(19) United States
(12) Patent Application Publication
(10) Pub. No.: US 2009/0000908 A1
(43) Pub. Date: Jan. 1, 2009

(54) Systems and methods for buffering articles in transport

(76) Inventors: Michael D. Brain, Los Gatos, CA (US); Chun-Chieh Lin, Taichung (TW)

Correspondence Address: CARR & FERRELL LLP, 2200 GENG ROAD, PALO ALTO, CA, 94303, US

(21) Appl. No.: 12/218,625

(22) Filed: Jul. 15, 2008

Related U.S. Application Data
(63) Continuation-in-part of application No. 12/002,850, filed on Dec. 18, 2007.
Application No. 12/002,850 is a continuation-in-part of application No. 11/764,755, filed on Jun. 18, 2007.
Application No. 11/764,755 is a continuation-in-part of application No. 11/406,569, filed on Apr. 18, 2006, now Pat. No. 7,281,623.
(60) Provisional application No. 60/840,169, filed on Aug. 25, 2006.
(60) Provisional application No. 60/805,085, filed on Jun. 18, 2006.
(60) Provisional application No. 60/805,084, filed on Jun. 18, 2006.

(51) Int. Cl. B65G 49/07; G06F 7/00

(52) U.S. Cl. 198/349.6; 700/226; 414/935

(57) ABSTRACT

A system for buffering articles in transport is provided. The system comprises a buffer module configured to buffer articles and a computing system. The buffer module includes a first conveyor configured to transport the articles and a transference node configured to transfer the articles between the first conveyor and an external location. The computing system is configured to maintain an inventory list including a present location of each of the articles buffered by the buffer module. The computing system is further configured to control operation of the buffer module to transfer a selected article among the buffered articles to the external location.

### CROSS-REFERENCE TO RELATED APPLICATIONS

This application is a continuation-in-part of U.S. application Ser. No. 12/002,850 filed on Dec. 18, 2007 and entitled “High Capacity Delivery with Priority Handling” which is a continuation-in-part of U.S. application Ser. No. 11/764,755 filed on Jun. 18, 2007 and entitled “Conveyor System Including Offset Section” which is a continuation-in-part of U.S. application Ser. No. 11/406,569 filed on Apr. 18, 2006 and entitled “Transport System Including Vertical Rollers,” now U.S. Pat. No. 7,281,623 issued on Oct. 16, 2007. U.S. application Ser. No. 11/764,755 filed on Jun. 18, 2007 also claimed the benefit of U.S. Provisional Application No. 60/840,169 filed on Aug. 25, 2006 and entitled “High Speed Transporter Including Horizontal Belt,” U.S. Provisional Application No. 60/805,085 filed on Jun. 18, 2006 and entitled “High Capacity Delivery with Priority Handling,” and U.S. Provisional Application No. 60/805,084 entitled “Pulley and Belt Profiles for Transport System Including Vertical Rollers” and also filed on Jun. 18, 2006. This application is also related to U.S. application Ser. No. 11/897,024 filed on Aug. 27, 2007 and entitled “High Speed Transporter Including Horizontal Belt,” U.S. application Ser. No. 11/818,657 filed on Jun. 14, 2007 and entitled “Systems and Methods for Transport Through Curves,” U.S. application Ser. No. 11/900,482 filed on Sep. 11, 2007 and entitled “Systems and Methods for Transport Through Curved Conveyance Sections,” U.S. application Ser. No. 11/897,013 filed on Aug. 27, 2007 and entitled “Conveyor Transfer System,” U.S. application Ser. No. 11/983,353 filed on Nov. 7, 2007 and entitled “Integrated Overhead Transportation System with Stationary Drive,” and U.S. application Ser. No. 11/764,161 filed on Jun. 15, 2007 and entitled “Transport System including Vertical Rollers.” Each of the aforementioned applications is incorporated herein by reference.

### BACKGROUND OF THE INVENTION

1. Field of the Invention

The present invention relates generally to the field of transport systems and more particularly to systems and methods for buffering articles in transport.

2. Description of the Prior Art

In semiconductor and other fabrication facilities there is a significant advantage to transporting work in process material at higher speeds throughout the facility while maintaining a high transport capacity with timely and predictable delivery times.

In semiconductor fabrication facilities particularly, semiconductor wafers are transported inside a carrier, called a FOUP, which is an acronym for Front Opening Unified Pod. The FOUP can be transported, for example, on a high speed device such as that disclosed in U.S. Pat. No. 7,281,623 issued on Oct. 16, 2007 and entitled “Transport System Including Vertical Rollers.” In that patent, a system is disclosed that can move FOUPs at high speeds supported between moving transport belts. As the FOUP approaches the vicinity of a next step in the process flow, the FOUP is transferred to a buffer location, to another transport mechanism, or directly to process or metrology equipment.

In transportation systems of the prior art, overhead buffers (OHB) have been used in conjunction with overhead transport (OHT) systems. However, the capacity of OHB's has been limited due to their placement below the tracks of the OHT systems. Furthermore, the placement of OHB's below the tracks of the OHT systems have limited OHB's placement to areas with OHT tracks. The OHT vehicles cannot be used for transporting FOUPs to and from process equipment during the time that the OHT vehicles are placing and retrieving FOUPs from an OHB, thereby limiting the throughput provided by the expensive OHT vehicles. In addition, while the OHT vehicle is placing or retrieving FOUPs from an OHB, other OHT vehicles on the same track may be blocked from proceeding to their destination.

In systems of the prior art, stockers have also been used to store FOUPs between process steps in a fabrication facility. However, the throughput of stockers has been limited. For example, a stocker typically can only input or output a single FOUP at a time, and a stocker robot may be occupied for approximately 20 seconds while storing or retrieving the FOUP. OHT vehicles may line up and be idle while waiting their turns to retrieve a FOUP from a stocker or deliver a FOUP to a stocker.

### SUMMARY

A system for buffering articles in transport is provided. The system comprises a buffer module configured to buffer articles and a computing system. The buffer module includes a first conveyor configured to transport the articles and a transference node configured to transfer the articles between the first conveyor and an external location. The computing system is configured to maintain an inventory list including a present location of each of the articles buffered by the buffer module. The computing system is further configured to control operation of the buffer module to transfer a selected article among the buffered articles to the external location.

A method for buffering an article in transport is provided. An available position among a plurality of buffered articles in a buffer system is first determined. The buffer system may include a conveyor, a first transference node, and a second transference node. The plurality of buffered articles in the buffer system are moved using the conveyor and the transference nodes such that the available position is at the first transference node. The article is loaded onto the buffer system at the first transference node. A position of a selected buffered article in the buffer system is determined. The plurality of buffered articles in the buffer system are moved using the conveyor and the transference nodes such that the selected buffered article is at the second transference node. The selected buffered article is unloaded from the buffer system at the second transference node.

A method for buffering an article in transport is provided. A train of buffered articles having available capacity to accept an input article is selected. The train of buffered articles may be stored by a buffer system comprising a conveyor and a transference node. The train of buffered articles is moved using the conveyor such that an input position is at the transference node. The input article is loaded onto the buffer system at the transference node. The train of buffered articles including the loaded input article is then moved to a storage position using the conveyor.

A computer readable storage medium having stored thereon computer readable instructions is provided. The computer readable instructions include a code segment to determine an available position among a plurality of buffered articles in a buffer system, where the buffer system comprises a conveyor, a first transference node, and a second transference node. The computer readable instructions also include a code segment to control the buffer system to move the plurality of buffered articles using the conveyor and the transference nodes such that the available position is at the first transference node. The computer readable instructions further include a code segment to control the buffer system to load the article onto the buffer system at the first transference node. Also, the computer readable instructions include a code segment to determine a position of a selected buffered article in the buffer system. Additionally, the computer readable instructions include a code segment to control the buffer system to move the plurality of buffered articles using the conveyor and the transference nodes such that the selected buffered article is at the second transference node. The computer readable instructions also include a code segment to control the buffer system to unload the selected buffered article from the buffer system at the second transference node.

### BRIEF DESCRIPTION OF DRAWINGS

FIG. 1 is a side view of a portion of a conveyor system within a fabrication facility, according to an embodiment of the present invention.

FIG. 2 is a top view of a portion of a conveyor system within a fabrication facility, according to an embodiment of the present invention.

FIG. 3 is an end view of a portion of a conveyor system within a fabrication facility, according to an embodiment of the present invention.

FIG. 4 is a top view of a portion of a conveyor system within a fabrication facility, according to an embodiment of the present invention.

FIG. 5 is a flowchart representation of a method of determining a route for an article through a conveyor system, according to an embodiment of the present invention.

FIG. 6 is a schematic illustration of a system of hardware emulation for performing simulations, according to an embodiment of the present invention.

FIG. 7 is a top view of a portion of a conveyor system including a buffer system within a fabrication facility, according to an embodiment of the present invention.

FIG. 8 is a top view of a portion of a conveyor system including an alternative buffer system within a fabrication facility, according to an embodiment of the present invention.

FIG. 9 is a top view of a portion of a conveyor system including another alternative buffer system within a fabrication facility, according to an embodiment of the present invention.

FIG. 10 is a top view of a portion of a conveyor system including yet another alternative buffer system within a fabrication facility, according to an embodiment of the present invention.

FIG. 11 is a top view of a portion of a conveyor system including an active stocker buffer system within a fabrication facility, according to an embodiment of the present invention.

FIG. 12A is a top view of a buffer module including conveyance sections, according to an embodiment of the present invention.

FIG. 12B is a top view of a buffer system comprising multiple repeatable buffer modules integrated together, according to an embodiment of the present invention.

FIG. 13 is a flowchart representation of a method of buffering articles in transport in a conveyor system, according to an embodiment of the present invention.

### DETAILED DESCRIPTION OF THE INVENTION

The present invention is directed to systems and methods for transporting articles, such as flat panel displays and semiconductor wafers within FOUPs, throughout a fabrication facility. According to the present invention, the articles can be buffered using conveyors. Overall system efficiency is improved by minimizing cycle times, by assuring that articles arrive at intended destinations within desired time windows, and by assuring that articles arriving at an intended destination arrive in a desired sequence. To achieve these goals, the present invention provides a buffer system using conveyors that integrate with transport conveyor systems, existing overhead transport (OHT) systems, and automated storage and retrieval systems (ASRS, also known as “stockers”). In some embodiments, the buffer system of the present invention may replace the stockers of the prior art to reduce use of floor space (i.e., “footprint”) in a fabrication facility and/or increase throughput of FOUPs. Transport systems comprising the present invention may also allow for alternative routing choices by including alternate routes such as parallel conveyors and nodes where articles can be switched between conveyors, the use of a hoist to bypass congested conveyor portions, or the use of prioritization of articles in transport. Accordingly, high priority articles can be routed around traffic by switching between parallel conveyors and/or lower priority articles can be rerouted or delayed to make a route less congested. Methods are provided for buffering articles using conveyors to optimize the delivery of articles.

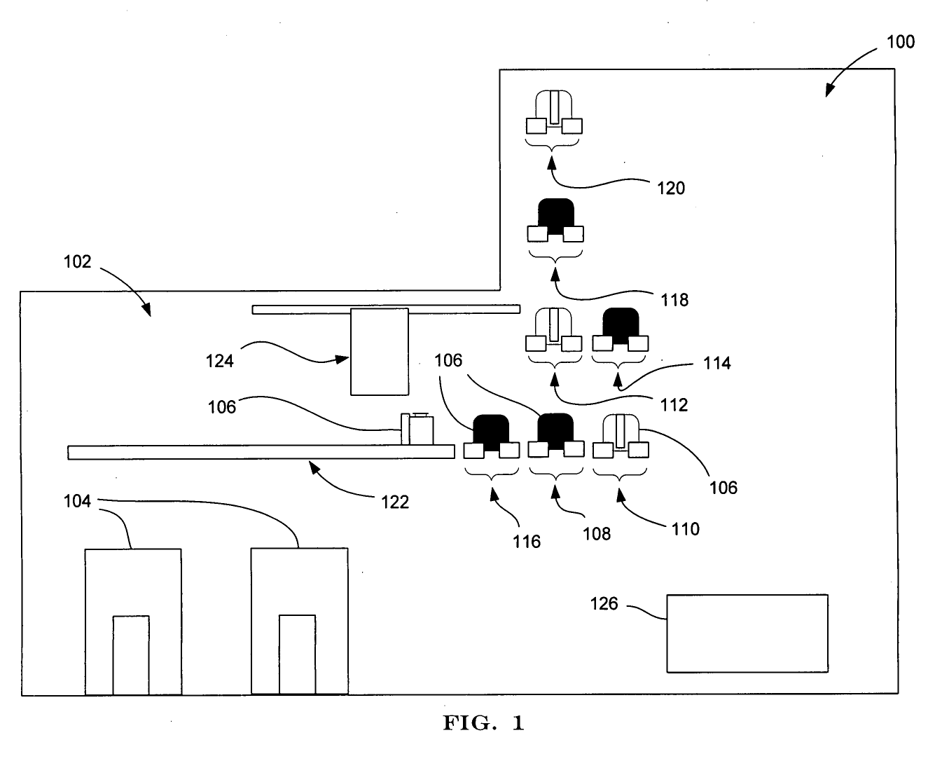

FIG. 1 illustrates a side view of an exemplary portion of a conveyor system within a fabrication facility. The illustrated portion comprises a central corridor 100 and an area 102 for process and/or metrology equipment 104. As can be seen in FIG. 1, a ceiling of the central corridor 100 can be higher than a ceiling of the area 102. It will be appreciated that the central corridor 100 can link multiple such areas 102 within the fabrication facility.

In FIG. 1, FOUPs 106 are transported along the central corridor 100 between areas 102 by conveyors 108, 110 in opposite transport directions that are perpendicular to the plane of the drawing. The central corridor 100 can optionally also comprise additional conveyors 112, 114 to provide additional transportation capacity and alternative routes through the fabrication facility. Such additional capacity can allow for load balancing as well as redundancy in the event of a failure. These additional conveyors 112, 114 can further be used to temporarily store FOUPs 106 in some instances. In some embodiments, the additional conveyors 112, 114 are reserved for use only by those FOUPs 106 with sufficiently high priority levels.

The additional conveyors 112, 114 are disposed above the conveyors 108, 110 in FIG. 1 but are not limited to this arrangement and can be alternatively disposed below or along side the conveyors 108, 110, for example. Further, it will be appreciated that the central corridor 100 can comprise still more conveyors than the two additional conveyors 112, 114. Also shown in FIG. 1 are a buffer conveyor 116 and two storage conveyors 118, 120. The functions of the various conveyors will be described in greater detail below.

The fabrication facility additionally comprises a conveyor 122 for conveying FOUPs 106 along the length of the area 102 and to and from the conveyors within the central corridor 100. In some embodiments, a mechanism such as a hoist 124 is used to transfer FOUPs 106 between the conveyor 122 and the equipment 104. Exemplary mechanisms for transferring FOUPs 106 between the conveyor 122 and the equipment 104 are described in U.S. application Ser. No. 11/983,353 filed on Nov. 7, 2007 and entitled “Integrated Overhead Transportation System with Stationary Drive.”

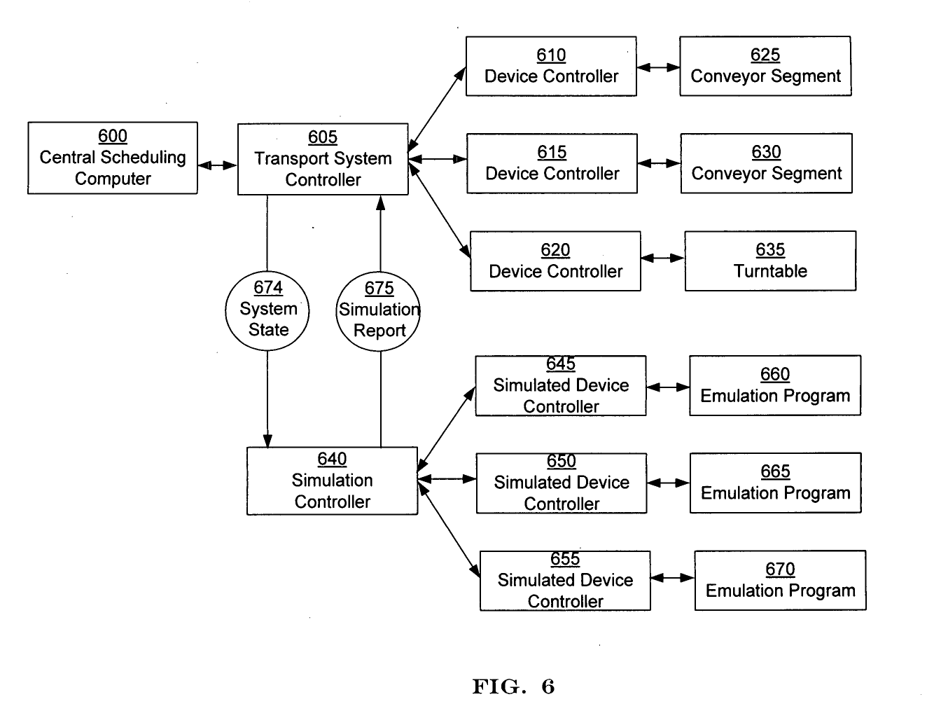

The fabrication facility additionally comprises a computing system 126. The computing system 126 communicates with the process and metrology equipment 104 and the transport system device controllers that control the various conveyors and associated transfer mechanisms to implement methods of the invention described below. Aspects of the computing system 126 are described in more detail with respect to FIG. 6.

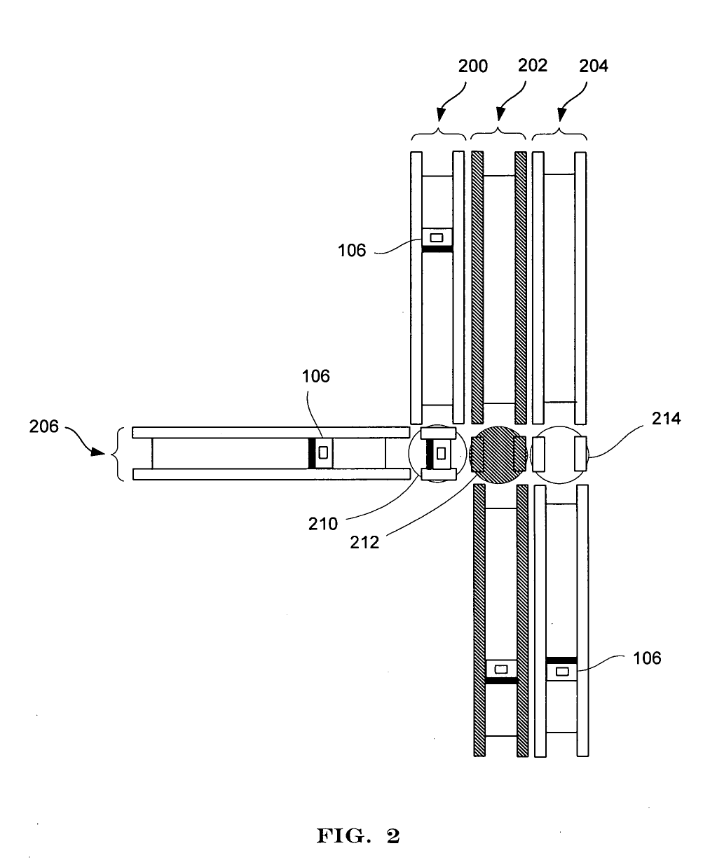

FIG. 2 illustrates a top view of a portion of an exemplary conveyor system within a fabrication facility. In FIG. 2, three parallel conveyors 200, 202, 204 extend within a central corridor (e.g. central corridor 100 of FIG. 1) and are met by a conveyor 206 disposed perpendicular to the conveyors 200, 202, 204 and extending within an area (e.g. area 102 of FIG. 1) for process and/or metrology equipment (e.g. equipment 104 of FIG. 1). Each of the conveyors 200, 202, 204, 206 in the illustrated embodiment comprises two belts for transporting FOUPs 106 therebetween, although it will be appreciated that other types of transportation can be used in place of these conveyors. Of the three conveyors 200, 202, 204, two conveyors 200, 202 are used to transport FOUPs 106 in opposite directions, as shown, while the third conveyor 204 serves as a buffer conveyor.

In the embodiment illustrated by FIG. 2, a turntable 210 comprises a node between the conveyors 204 and 206 at which FOUPs 106 can be transferred from one conveyor 204, 206 to the other 206, 204. Additional turntables 212, 214 are disposed between conveyor segments of the conveyors 200, 202. Suitable turntables are described in more detail in U.S. application Ser. No. 11/818,657 filed on Jun. 14, 2007 and titled “Systems and Methods for Transport Through Curves.” A node for transferring FOUPs 106 between two parallel conveyors 202, 204 exists where each conveyor 202, 204 includes an adjacent turntable 212, 214. In FIG. 2, the turntables 212, 214 in line with the turntable 210 so that FOUPs 106 can also be routed between conveyor 206 and either of the two conveyors 200, 202.

Any of the turntables 210, 212, 214 can be configured with an elevator that will allow a FOUP 106 to be moved vertically to another conveyor in a higher or lower layer than the illustrated layer. Any of the turntables 210, 212, 214 can also be replaced by other FOUP 106 transfer mechanisms. Other suitable transfer mechanisms are described in U.S. application Ser. No. 11/897,013 filed on Aug. 27, 2007 and entitled “Conveyor Transfer System.”

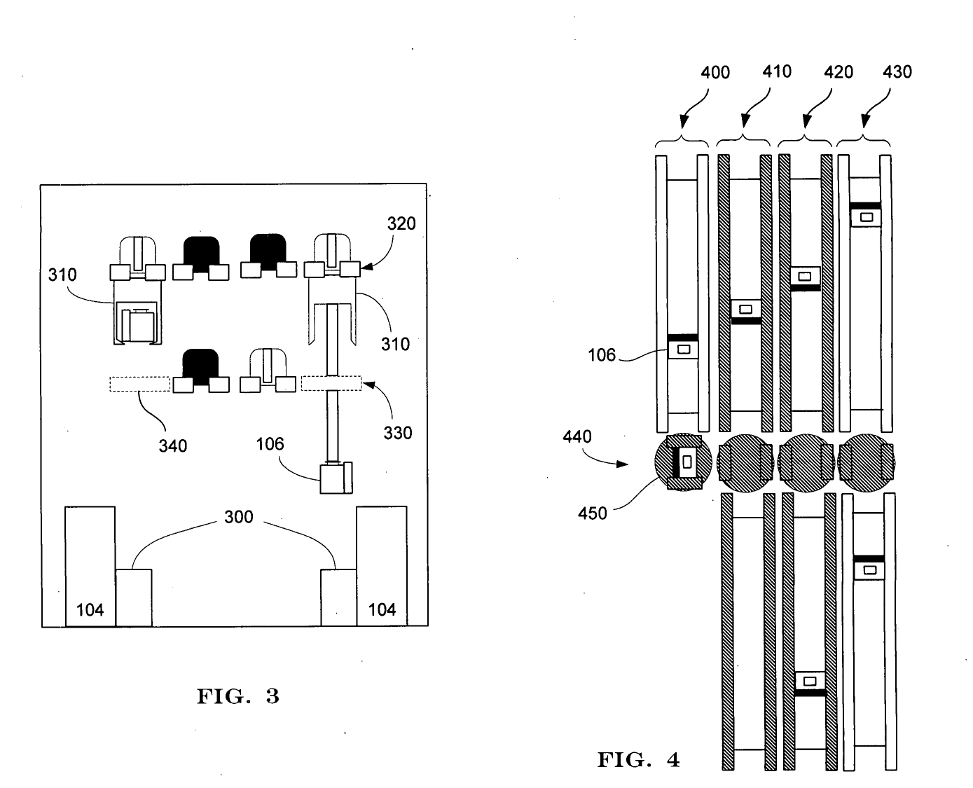

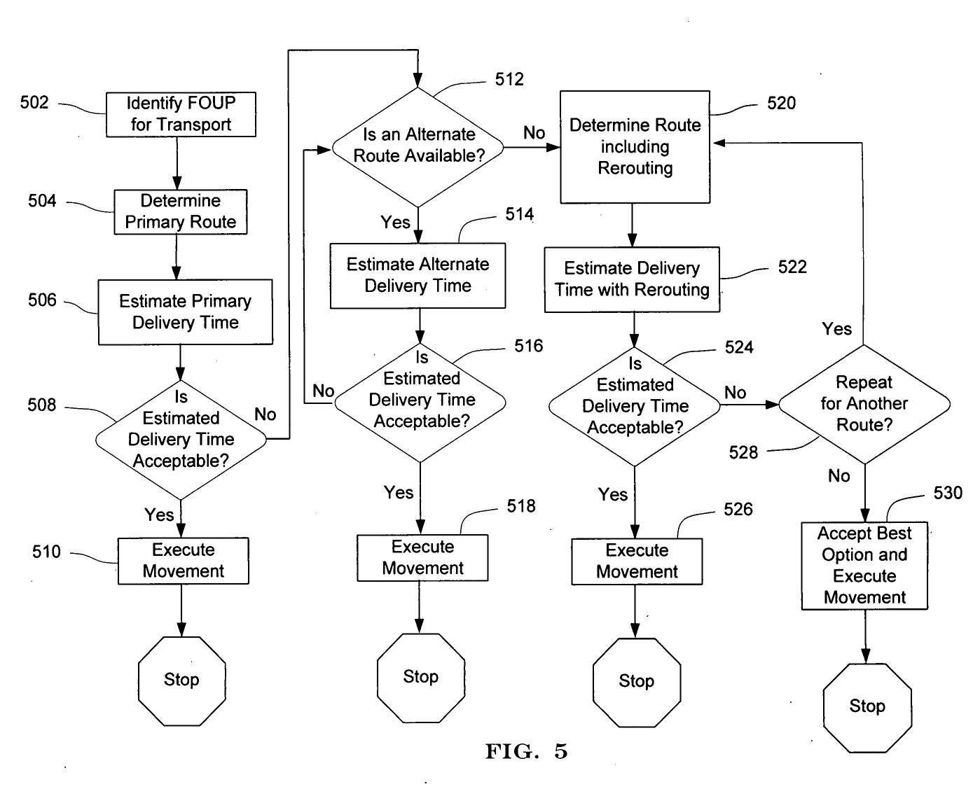

FIGS. 3 and 4 show an end view and a top view, respectively, of an exemplary aisle such as would run the length of the area 102 (FIG. 1). Since factory space is expensive, especially in a clean factory such as is necessary for semiconductor or flat panel fabrication, it is desirable to minimize the footprint of the fabrication facility which can be achieved, at least in part, by making the aisles between equipment 104 as narrow as possible. In some embodiments, the load ports 300 of the equipment 104 are located close together, such as 1.6, 2.0, or 2.4 meters from load port center line to center line. In FIG. 3, exemplary hoists 310 are used to transfer FOUPs 106 between the equipment load ports 300 and the overhead conveyors.

As noted above with respect to the conveyors in the central corridor 100 (FIG. 1), multiple transport and buffering conveyors can be arranged in layers in the space above the aisle. One such layer, illustrated by FIG. 4, includes a buffer conveyor 400, three transport conveyors 410, 420, 430, and a node 440 comprising four turntables 450. Such conveyors 400, 410, 420, 430 and nodes 450 allow FOUPs 106 with higher priorities to be delivered more rapidly, while FOUPs 106 with lower priorities may continue to be transported or may be buffered.

In some embodiments, one or more layers of conveyors are used to transport FOUPs 106 into and out of the aisle, while another layer of conveyors is provided for buffering FOUPs 106. If the equipment 104, or a hoist 310 configured to service the equipment 104, are not immediately ready to receive a FOUP 106 that is brought into the aisle in a transport layer 320, the FOUP 106 may be transferred to a buffer layer 330 where the FOUP 106 can be held until the equipment 104 is available. The FOUP 106 can be transferred between transport layer 320 and buffer layer 330, for example, with an elevator (not shown) configured to raise and lower a turntable 450. FOUPs 106 held in the buffer layer 330 will not interfere with the transport of FOUPs 106 in the transport layer 320. When a FOUP 106 is to be retrieved from the buffer layer 330, the FOUP 106 may be moved to a buffer transfer port 340 for a hoist 310 to pick up and deliver to the equipment load port 300. In one alternative embodiment of the invention, the transport layer 320 is disposed below the buffer layer 330.

As shown in FIG. 4, FOUPs 106 within a layer can be transferred between conveyors 400, 410, 420, 430 in the layer at nodes 440. A node can also comprise a mechanism for transferring a FOUP 106 between conveyors within different layers, such as a turntable 450 configured with an elevator. It will be appreciated that if any portion of the conveyor system fails or is blocked with traffic at any time, conveyors within a layer or within other layers, and the nodes that connect the various conveyors, can be used to provide a route around the problem. The use of turntables and elevators in this manner is equally applicable to routing around problems within the central corridor 100.

An exemplary method of selecting a route for a FOUP through a semiconductor fabrication facility is illustrated by the flowchart in FIG. 5. Even though the method is described in terms of conveying FOUPs for transporting semiconductor wafers, it will be appreciated that the method is generally applicable to routing articles through fabrication facilities dedicated to manufacturing other devices, such as flat panel displays. The steps of the method described below can be performed, for example, by a computing system (e.g. computing system 126 of FIG. 1).

The method shown in FIG. 5 begins in a step 502 of identifying a FOUP that is ready for transport. For instance, the FOUP may be disposed at a first location (a.k.a. the source) and loaded with wafers that are ready for metrology or processing at a second location (a.k.a. the destination). Here, the FOUP can be identified, for example, by receiving a signal from a metrology or processing tool that the door of the FOUP has been closed. Step 502 can include assigning a priority level to the FOUP based on considerations such as whether the destination metrology or processing tool is immediately available, or already has FOUPs in process or waiting.

In a step 504 a determination is made of a primary route from the source to the destination. The determination can be made by checking a database or by executing a routing algorithm that can find the shortest route, in various embodiments. While in some instances the primary route that is determined in step 504 comprises a physical path through the conveyor system, it will be appreciated that the primary route can also comprise a timing element, as well. In some embodiments, the primary route also specifies for the FOUP a scheduling slot the route. Scheduling slots are also referred to as time slices herein, and an exemplary time slice is 15 seconds.

Next, in a step 506, a primary delivery time is estimated for the primary route. The primary delivery time may be estimated by calculating the distance to be traveled multiplied by an average expected speed, for example. The average expected speed may be a set constant or can be determined based on the current or expected volume of traffic on the primary route. The primary delivery time may also be estimated by more complex methods that model the delivery times for the individual conveyors and other components of the primary route. For the purposes of such modeling, or for making a determination of the average expected speed, the amount of traffic already on, or expected on, the primary route can be determined.

In a step 508, a determination is made as to whether or not the primary delivery time is acceptable. This determination can be made by comparing the primary delivery time to a desired arrival time. The desired arrival time can be provided by a scheduling algorithm, in some embodiments. In other instances, each level of priority is associated with a range of acceptable transport times or a maximum acceptable transport time. Thus, the desired arrival time for a FOUP with an assigned priority level can be determined by cross-referencing the priority level against a table. If the primary delivery time meets the desired time, then the primary delivery time is acceptable and the transport movement of the FOUP according to the primary route is executed in a step 510.

On the other hand, if the primary delivery time is not acceptable, then an alternate route from the source to the destination may be determined in a step 512. As in step 504, the determination can be made by checking the database or by executing the routing algorithm to find the next shortest route, in various embodiments. Due to traffic or other such problems, the alternate route may include the use of buffer conveyors in the transport or buffer layers, as described above.

If an alternate route is available, then in step 514 a secondary delivery time is calculated for the alternate route as described above with respect to step 506. A determination is then made in a step 516 as to whether or not the secondary delivery time is acceptable as described above with respect to step 508. If the secondary delivery time meets the desired time, then the secondary delivery time is acceptable and the transport movement of the FOUP according to the secondary route is executed in a step 518.

If the secondary delivery time is not acceptable, then steps 512-516 can be repeated until either an acceptable route is found, all alternate routes have been tested, or a threshold number of iterations through steps 512-516 has been met. If no acceptable alternate route is found then in a step 520 a determination can be made as to whether rerouting one or more FOUPs would make a delivery time for the primary or any alternate routes acceptable.

In some embodiments, FOUPs considered for rerouting are those FOUPs having lower assigned priority levels. Rerouting a FOUP can comprise, for example, moving the FOUP onto a buffer conveyor or onto another transport conveyor. Rerouting a FOUP can also comprise holding a FOUP from entering the transport system until after the higher priority FOUP has passed. In some embodiments, step 520 includes identifying and resolving specific instances of routing conflicts between FOUPs, as discussed further below.

In a step 522 another primary delivery time is calculated for the primary route as described above with respect to step 506, but in this instance taking into account the proposed rerouting of certain FOUPs. A determination is then made in a step 524 as to whether or not the newly calculated delivery time is acceptable as described above with respect to step 508. If acceptable, the transport movement of the FOUP according to the primary route along with the rerouting of the certain FOUPs are executed in a step 526. If not acceptable, a determination can be made in a step 528 as to whether to repeat steps 520-524 with a previously considered alternate route. In some embodiments, the determination to repeat steps 520-524 is made so long as previously identified alternate routes have not yet been tested with rerouting. In other embodiments, if a threshold number of alternate routes have already been tested with rerouting, a determination not to repeat steps 520-524 is made. If no acceptable combination of an alternative route with rerouting of certain FOUPs exists, then the best option amongst the options previously deemed unacceptable is selected and the movement of the FOUP, and the rerouting of certain other FOUPs, if beneficial, is executed in a step 530.

Referring again to step 520, if low priority FOUPs are rerouted to allow a higher priority FOUP to reach a destination more rapidly, a traffic jam can result much like a presidential limousine and entourage can cause a traffic problem when given priority over regular traffic in an urban rush hour. To prevent this, some embodiments of the invention include systems and methods of accommodating a higher priority FOUP with reduced effect on other traffic.

For instance, in some embodiments, a score is calculated for each FOUP movement, where a FOUP movement represents the act of transporting a FOUP to a destination such as process or metrology equipment. The scores can then be used to evaluate routing decisions in step 520. The score for a FOUP can simply be a function of the priority level for the FOUP, or can be further modified based on various considerations. In one example, 10 points are allotted to any FOUP assigned the highest priority. If a process or metrology equipment will sit idle until the FOUP arrives, then the 10 points assigned to the FOUP is multiplied by a weighting factor that represents the length of time the equipment will be idle or the cost of having the equipment sit idle. These weighting factors may be dependent on the particular equipment and/or the overall load and capacity of the particular equipment and/or the expected impact on facility output.

Continuing with the example above, a weighting factor for a particular equipment at a particular time is given a value of 10. In this case, the 10 points assigned to the FOUP to designate the highest priority level are multiplied by the weighting factor of 10 to determine an overall score for the FOUP movement of 100. When a potential route to deliver this FOUP is evaluated in step 520, any FOUP movement scoring less than 100 points along the route under evaluation can be considered for rerouting. Any FOUP movement scoring 100 points or more would not be considered for rerouting.

To prevent traffic jams of the sort mention above, in some embodiments, the sum of the scores of any proposed rerouted FOUP movements cannot exceed the score of the FOUP movement being evaluated. Thus, a 100 point FOUP movement will take priority over two 40 point FOUP movements but would not take priority over two 90 point FOUP movements or over six 20 point FOUP movements.

In addition to the cost of having equipment sit idle, weighting factors can also be based on a cost of having a FOUP wait. The score for a FOUP movement, therefore, can be calculated in some embodiments by multiplying the points assigned to the FOUP to designate priority by a weighting factor based on the wait time. While a weighting factor can simply be proportional to the wait time, the weighting factor may also be adjusted to take into account that the cost of having a FOUP 106 wait may be a function of the availability schedule of equipment. For example, the cost of having a FOUP wait is reduced if the destination equipment is already in use and will still be unavailable when the FOUP arrives after the proposed wait. Certain equipment may be designated as bottleneck equipment, whose capacity has more direct impact on the factory output and therefore preventing this equipment from being idle will be given a higher weighting. Such costs may be calculated for a number of time slices in the future, and weighting factors can be dependent upon the costs as a function of time. Additionally, it will be understood that calculating a score for a FOUP movement is not limited to multiplying together a number of points for a priority level by every weighting factor, but can alternatively include, for instance, adding the products of the priority points with several weighting factors.

In some embodiments, determining whether a FOUP should be rerouted in step 520 can include adjusting the score of the FOUP movement for that FOUP to account for the costs of rerouting that FOUP. It will be appreciated that a cost analysis can be incorporated into the method illustrated by FIG. 5 and may include several stages. For example, at step 506 a first cost analysis of the cost of taking the primary route can be performed along with the estimation of the primary delivery time. In some embodiments, even if the primary delivery time is acceptable, the method may then continue to determine an alternate route and a cost of taking the alternate route. Where the cost of taking the alternate route is lower than that of the primary route, if the secondary delivery time is still acceptable, would make the alternate route more desirable than the primary route. The same analysis can continue by considering routes in which other FOUPs are rerouted. In some embodiments, other approaches seek to minimize the total costs and/or maximize the system wide benefits of routing decisions.

To further improve the system wide performance, the system may determine if a lower priority FOUP or FOUP movement in the route of a higher priority FOUP will actually impact the delivery time of the priority FOUP. In some embodiments, this is accomplished by examining a plurality of pending FOUP movements in a database, analyzing the pending FOUP movements by time slice, and locating route intersections. In some embodiments, when two FOUP routes are predicted to interfere, the lower priority FOUP movement can be diverted to another route or kept on the same route but either sped up or delayed to avoid the predicted conflict. In some embodiments, speeding up or delaying a FOUP can be accomplished by moving the FOUP into a different time slice for the route. In some embodiments, a simulation of the real system is created to determine the routes' intersections. The simulation can then be re-run with the lower priority FOUP movements rerouted to verify that new conflicts have not been created.

FIG. 6 illustrates a system of hardware emulation for performing simulations as described above. The system comprises a central scheduling computer 600 configured to issue movement commands to a transport system controller 605 which in turn is configured to send individual movement commands to exemplary transport system device controllers 610, 615, and 620 which control individual transport mechanisms such as conveyor segments 625, 630 and turntable 635.

Prior to initiating a FOUP movement, the transport system controller 605 may send the system state 674 (e.g., the current system status and current movement command queue) to a simulation controller 640 that may be a second instance of the transport system controller 605 and is provided to perform simulations. The simulation controller 640 may include a copy of the controller logic (e.g., software) and/or a copy of the controller hardware (e.g., processor and/or firmware). The simulation controller 640 is connected to a network of simulators 645, 650, 655 of the transport system device controllers 610, 615, 620. While the simulators 645, 650, 655 can be complete duplicates of the transport system device controllers 610, 615, 620, the simulators 645, 650, 655 can instead be merely copies of the device control programs being executed by the transport system device controllers 610, 615, 620. Accordingly, the simulators 645, 650, 655 need not be spatially separate as suggested by FIG. 6, but can be operating on a single computing system, even the same computing system of the simulation controller 640.

Since the simulators 645, 650, 655 do not control actual devices, the simulators 645, 650, 655 are instead connected to device emulation programs 660, 665 and 670. The device emulation programs 660, 665, 670 accept the motor and digital output commands from the simulators 645, 650, 655 and respond with status replies and digital output data that precisely emulate the actual transport mechanisms.

After a simulation of a FOUP movement has been completed, the simulation controller 640 can output a simulation report 675. The simulation report 675 can be a simple pass/fail indication, a summary of conflicts or near-conflicts that would occur if the FOUP movement were to actually be performed, or a detailed representation of the positions of the various FOUPs 106 as a function of time. The simulation report 675 can be transmitted back to the transport system controller 605 so that the transport system controller 605 can either initiate the proposed FOUP movement or propose a different FOUP movement back to the simulation controller 640. The simulation report 675 can also be used as feedback to validate the accuracy of the simulation.

By constructing the simulation environment to operate at a higher speed than the actual environment, the simulation report 675 may be obtained quickly so that the results therein can be used by the transport system controller 605 or other factory control systems or personnel to make better decisions. A variety of different time slices may be useful depending on factors such as the number of FOUP movements currently in process or in the queue, or the length of time required to complete those movements. In the event that events in the actual system do not match those estimated by the simulation, an early warning of system problems may be generated.

In alternative embodiments, simulation of system performance is performed using a distributed approach. In some of these embodiments, each routing element of a distributed system has a local controller responsible for a portion of the system. Each local controller is aware of the FOUPs 106 that are intended to enter that portion as input and configured to estimate when those FOUPs 106 will leave the portion as output. The local controller can then predict when each FOUP 106 will be delivered as output and communicate that information to another local controller for a neighboring portion that will receive the FOUP 106. Through a full series of these communications each local controller will then build a full list of the FOUPs 106 that are expected through the next number of minutes, for example two, five, 10, or 20 minutes. Then, if central scheduling computer 600 wishes to send a new FOUP 106 along a route, then each local controller along the route can be given a request to schedule the new FOUP 106 with a given priority. As each local controller stores this reservation and calculates an output time, that local controller can check for any conflicts to other reservations. Such conflicts can then be reported to the transport system controller 605 for resolution. Alternatively, the local controller could act to give the proper movement priority and notify subsequent local controllers of the updated reservation times for any effected FOUPs 106.

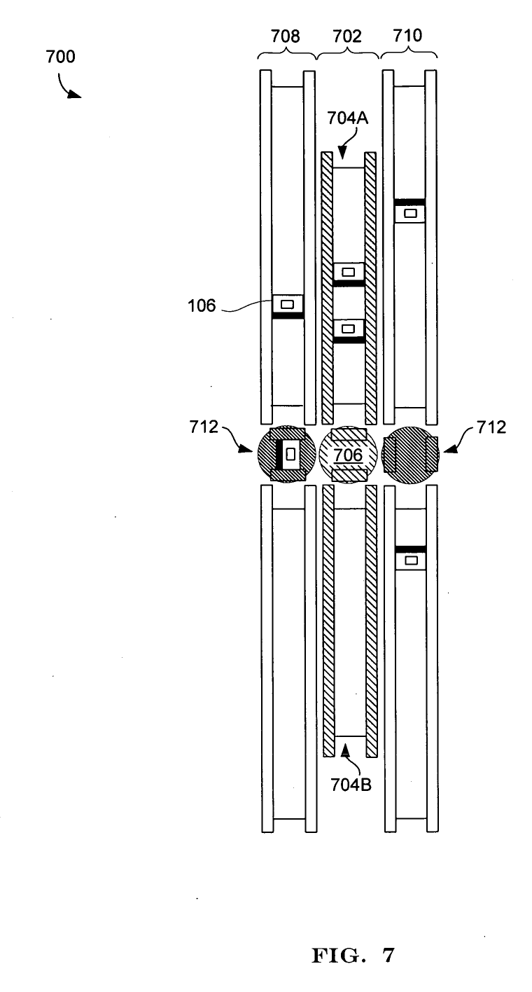

FIG. 7 is a top view of a portion of a conveyor system 700 including a buffer system 702 within a fabrication facility, according to an embodiment of the present invention. The buffer system 702 may include an example of the buffer conveyor 400. The buffer system 702 comprises a first buffer conveyor 704A, a second buffer conveyor 704B, and a turntable 706. The turntable 706 comprises a transference node between the buffer conveyors 704 and conveyors 708 and 710. In some embodiments, the conveyor 708 may transport FOUPs 106 in an opposite direction than the conveyor 710. The conveyors 708 and 710 each comprise a turntable 712 configured to transfer selected FOUPs 106 to the transference nodes of the buffer system 702 and receive selected FOUPs 106 from the transference nodes of the buffer system 702.

The buffer system 702 may be integrated with a transport system that includes conveyors 708 and 710 in configurations and locations as varied as those pertaining to the transport system itself. The buffer system 702 may include conveyors of the same type as the conveyors 708 and 710, which may lower costs and improve maintainability. By integrating the buffer system 702 with the transport system, the FOUPs 106 may be stored near to locations where the FOUPs 106 may next be needed or recently left. The integration of the buffer system 702 with the transport system may eliminate time consuming intermediate handoffs to stockers.

In various embodiments, the buffer conveyors 704 may include one or more individual conveyance sections. The individual conveyance sections may include straight conveyance sections, curved conveyance sections, curvilinear conveyance sections, inclined conveyance sections, and declined conveyance sections. The straight conveyance sections may transport the FOUPs 106 in a straight path, while the curved conveyance sections may transport the FOUPs 106 in a continuously curved path, as described in U.S. application Ser. No. 11/900,482 filed on Sep. 11, 2007 and entitled “Systems and Methods for Transport Through Curved Conveyance Sections.” The curvilinear conveyance sections may transport the FOUPs 106 in a path configured to incrementally turn the FOUPs 106 at points separated from each other by a distance in which the FOUPs 106 travel an approximately straight path, as described in U.S. Pat. No. 7,281,623 entitled “Transport System Including Vertical Rollers.” The inclined and declined conveyance sections may change an elevation of the FOUPs 106 while transporting the FOUPs 106 along an inclined or declined path. Each of the individual conveyance sections may include its own motorized rollers and/or belts configured to move the FOUPs 106. All of the individual conveyance sections included in a single buffer conveyor 704 may be controlled to function as if they were a single unit. For example, all of the individual conveyance sections may move the FOUPs 106 in the same direction at a given time.

The buffer conveyors 704 may be controlled by an electronic control unit or a computing system (e.g., the computing system 126), which may include control logic and a processor. The control logic may be embodied in read-only memory, firmware, nonvolatile memory, integrated circuits, software, and/or computer readable storage media (e.g., compact discs, hard drives, digital versatile discs (DVDs), flash memory, etc.). The buffer conveyors 704 may be controlled to function in concert with one another to buffer and/or store the FOUPs 106. The buffer conveyors 704 may each be configured to move the FOUPs 106 either toward or away from the turntable 706 under control of the computing system 126. For example, some FOUPs 106 stored on the buffer conveyor 704A may be moved to the buffer conveyor 704B when the buffer conveyor 704A is configured to move the FOUPs 106 toward the turntable 706, the turntable 706 is configured to move the FOUPs 106 from the buffer conveyor 704A to the buffer conveyor 704B, and the buffer conveyor 704B is configured to move the FOUPs 106 away from the turntable 706. In this way, the buffer system 702 may be configured to provide random access functionality (e.g., to output any FOUP 106 stored in the buffer system 702 to either the conveyor 708 or 710 without first outputting any other FOUP 106), as long as the total number of FOUPs 106 stored in the buffer system 702 is not greater than the storage capacity of either the buffer conveyor 704A or the buffer conveyor 704B. When the total number of FOUPs 106 stored in the buffer system 702 is greater than this number, the buffer system 702 may provide first in first out (FIFO) functionality or a combination of FIFO and random access functionality.

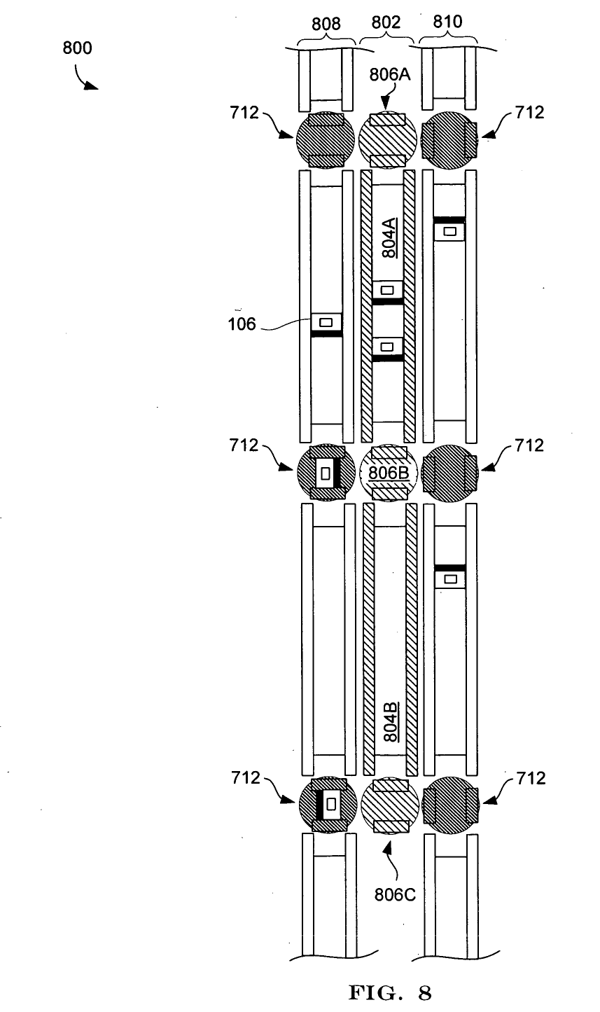

FIG. 8 is a top view of a portion of a conveyor system 800 including an alternative buffer system 802 within a fabrication facility, according to an embodiment of the present invention. The buffer system 802 comprises a first buffer conveyor 804A, a second buffer conveyor 804B, and turntables 806A, 806B, and 806C. The turntables 806 comprise transference nodes between the buffer conveyors 804 and conveyors 808 and 810. In some embodiments, the conveyor 808 may transport FOUPs 106 in an opposite direction than the conveyor 810. The conveyors 808 and 810 each comprise turntables 712 configured to transfer selected FOUPs 106 to the transference nodes of the buffer system 802 and receive selected FOUPs 106 from the transference nodes of the buffer system 802.

The buffer system 802 is similar to the buffer system 702 except that the buffer system 802 has additional transference nodes at both ends. The additional transference nodes at both ends, which include the turntables 806A and 806C, facilitate greater flexibility in storing the FOUPs 106 in and retrieving the FOUPs 106 from the buffer system 802. For example, the buffer system 802 may function as either a FIFO or a first in last out (FILO) buffer up to its maximum storage capacity. In some embodiments, a segment of the conveyor 808 or the conveyor 810 between any pair of the turntables 806 may be controlled to rotate the FOUPs 106 stored in the buffer system 802 to access any selected FOUP 106 in the buffer system 802. In this way, the buffer system 802, in conjunction with the conveyors 808 or 810, may operate as a random access buffer even when storing its maximum capacity of the FOUPs 106. Various embodiments may include additional buffer conveyors 804 and turntables 806 for increased capacity and flexibility.

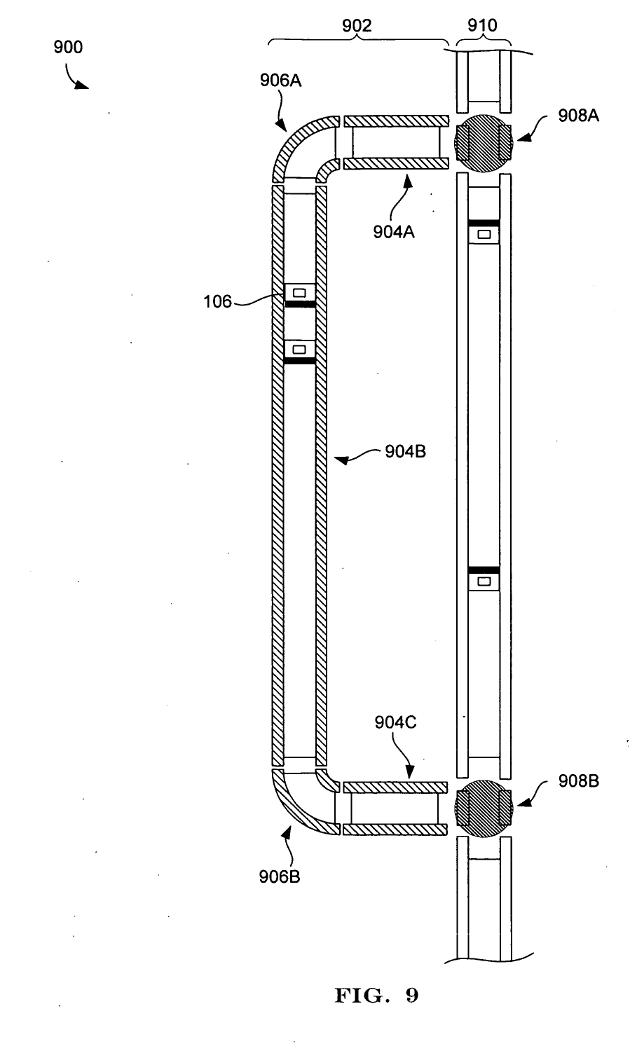

FIG. 9 is a top view of a portion of a conveyor system 900 including another alternative buffer system 902 within a fabrication facility, according to an embodiment of the present invention. The buffer system 902 comprises a first buffer conveyor 904A, a second buffer conveyor 904B, a third buffer conveyor 904C, and curved buffer conveyors 906A and 906B. The curved buffer conveyors 906 may include curved conveyance sections and/or curvilinear conveyance sections as described above. The conveyor 910 comprises turntables 908A and 908B configured to transfer selected FOUPs 106 to and from the buffer system 902.

The buffer system 902 is similar to the buffer system 802 except that the buffer system 902 includes curved buffer conveyors 906 and does not include a transference node in between the ends. The curved buffer conveyors 906 may improve the speed with which the FOUPs 106 may be moved through the buffer system 902 from one end (e.g., the end of the buffer conveyor 904A near the turntable 908A) to the other (e.g., the end of the buffer conveyor 904C near the turntable 908B). The buffer system 902 may function as either a FIFO or a FILO buffer up to its maximum storage capacity. In some embodiments, a segment of the conveyor 910 between the turntables 908A and 908B may be controlled to rotate the FOUPs 106 stored in the buffer system 902 to access any selected FOUP 106 in the buffer system 902. In this way, the buffer system 902, in conjunction with the conveyor 910, may operate as a random access buffer. Various embodiments may include additional buffer conveyors 904, curved buffer conveyors 906, and turntables 908 for increased capacity and flexibility.

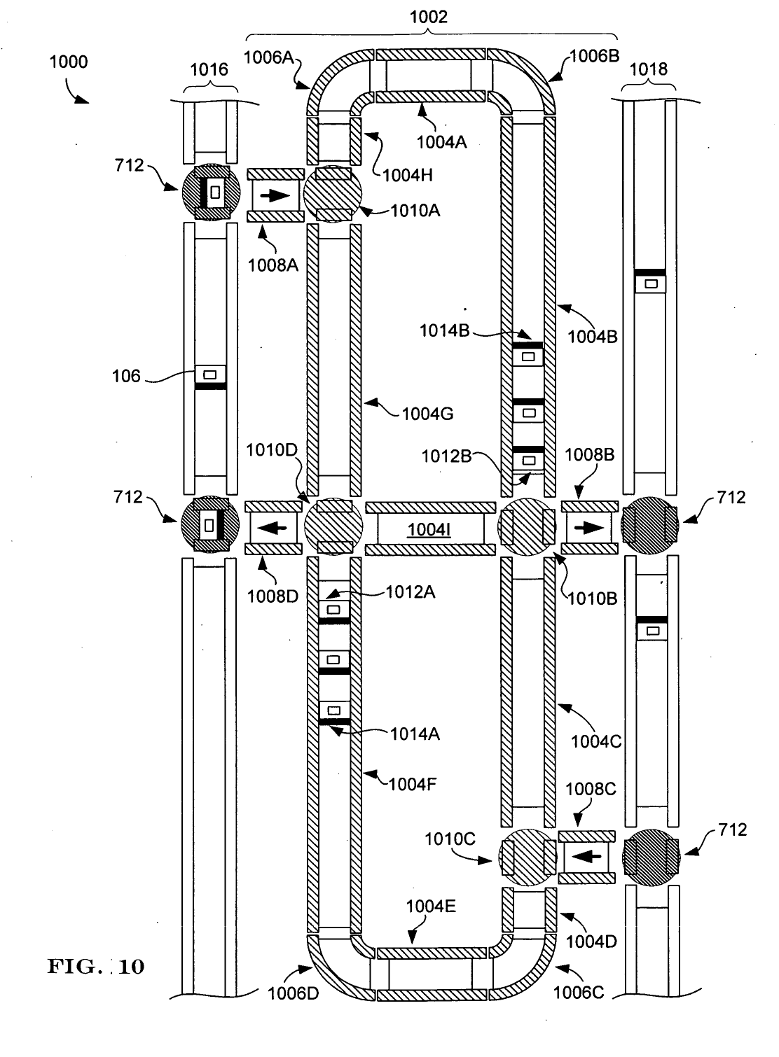

FIG. 10 is a top view of a portion of a conveyor system 1000 including yet another alternative buffer system 1002 within a fabrication facility, according to an embodiment of the present invention. The buffer system 1002 comprises buffer conveyors 1004A, 1004B, 1004C, 1004D, 1004E, 1004F, 1004G, and 1004H. The buffer system 1002 also comprises curved buffer conveyors 1006A, 1006B, 1006C, and 1006D, which may be configured to turn the FOUPs 106 between buffer conveyors 1004 as the FOUPs 106 are rotated through the buffer system 1002.

The buffer system 1002 further comprises buffer I/O conveyors 1008A, 1008B, 1008C, and 1008D. The buffer I/O conveyors 1008 may be configured to receive the FOUPs 106 into the buffer system 1002 for buffering and/or storage. The buffer I/O conveyors 1008 may be further configured to deliver the FOUPs 106 from the buffer system 1002 to the conveyors 1016 and/or 1018 upon demand (e.g., under control of the computing system 126). In various embodiments, the buffer I/O conveyors 1008 may comprise one or more individual conveyance sections. The individual conveyance sections may include straight conveyance sections, curved conveyance sections, curvilinear conveyance sections, inclined conveyance sections, and declined conveyance sections. The buffer I/O conveyors 1008 may be configured to be routed to areas remote from the conveyors 1016 and/or 1018 such that the buffer system 1002 may be located in available space to minimize footprint in a fabrication facility, such as over chase or maintenance areas. The buffer I/O conveyors 1008 may also be configured to connect the buffer system 1002 to other buffer systems, transport systems, and/or fabrication equipment, such as OHT vehicles and/or stockers.

Each individual buffer I/O conveyor 1008 may be configured to operate as a dedicated input port, or operate as a dedicated output port, for the buffer system 1002. For example, the buffer I/O conveyors 1008A and 1008C, which are near to the ends of the buffer system 1002, may be configured to operate as dedicated input ports. Likewise, the buffer I/O conveyors 1008B and 1008D, which are near the middle of the buffer system 1002, may be configured to operate as dedicated output ports. The buffer system 1002 may be more efficient for storage and retrieval of the FOUPs 106 in this configuration because the buffer system 1002 has more space on either side of transference nodes near buffer I/O conveyors 1008B and 1008D to shift the FOUPs 106 without turning the FOUPs 106 when accessing a selected FOUP 106 for delivery to the conveyor 1016 or 1018.

The buffer system 1002 additionally comprises turntables 1010A, 1010B, 1010C, and 1010D. The turntables 1010 comprise transference nodes between the buffer conveyors 1004 and buffer I/O conveyors 1008. The turntables 1010 may be configured to transfer selected FOUPs 106 between the buffer conveyors 1004 and the buffer I/O conveyors 1008.

The buffer system 1002 may be configured to store the FOUPs 106 in groups, or “trains,” on the buffer conveyors 1004. The trains may be configured with head positions 1012A and 1012B, and tail positions 1014A and 1014B. In some embodiments, any two individual FOUPs 106 within a train may have a distance therebetween (e.g., a spacing) of less than a dimension (e.g., length along a conveyance direction) of an individual FOUP 106. For example, the spacing between any two individual FOUPs 106 may be less than 400 mm, 300 mm, 100 mm, 50 mm, or 10 mm. For rapid delivery of the selected FOUP 106, the head positions 1012 may be configured to be near to output nodes, such as the transference nodes near the buffer I/O conveyors 1008B and 1008D. For example, the head positions 1012 may be configured to be on buffer conveyors 1004 adjacent to output nodes. In some embodiments, a distance between the head positions 1012 and the output nodes may be less than a dimension of the FOUPs 106. The buffer system 1002 may be configured to minimize empty spaces between the head positions 1012 and the tail positions 1014.

A maximum storage capacity of a single buffer conveyor 1004 may be dependent upon the buffer conveyor 1004's length. For example, a buffer conveyor 1004 that is 1.8 m in length may have a storage capacity of three or four FOUPs 106. As another example, a buffer system 1002 that includes four buffer conveyors 1004, each of which has a length of 1.8 m, may have a total storage capacity of twelve to sixteen FOUPs 106.

In some embodiments, the conveyor 1016 may transport the FOUPs 106 in an opposite direction than the conveyor 1018. The conveyors 1016 and 1018 each comprise turntables 712 configured to transfer selected FOUPs 106 to the transference nodes of the buffer system 1002 and receive selected FOUPs 106 from the transference nodes of the buffer system 1002.

The buffer system 1002 may be configured to rotate the FOUPs 106 in storage in a complete loop, thereby providing full random access functionality without interrupting traffic on conveyors of the transport system to which the buffer system 1002 is connected, such as conveyors 1016 and 1018.

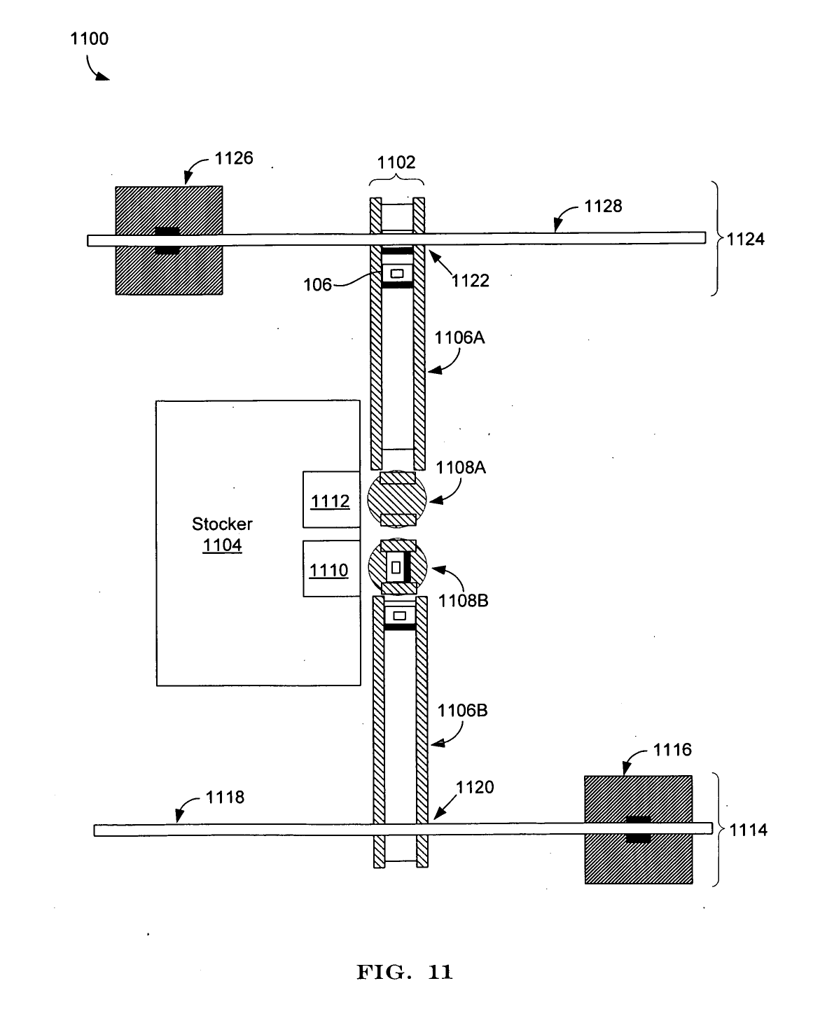

FIG. 11 is a top view of a portion of a conveyor system 1100 including an active stocker buffer system 1102 within a fabrication facility, according to an embodiment of the present invention. The active stocker buffer system 1102 may be configured to transport FOUPs 106 to a stocker 1104 for storage and transport the FOUPs 106 from the stocker 1104 after retrieval. The active stocker buffer system 1102 may receive the FOUPs 106 from and/or deliver the FOUPs 106 to a variety of equipment, including conveyor systems, OHT systems, fabrication process equipment, other stockers, etc. The active stocker buffer system 1102 may comprise additional buffer systems, e.g., the buffer systems 702, 802, 902, and/or 1002.

The active stocker buffer system 1102 comprises buffer conveyors 1106A and 1106B and turntables 1108A and 1108B. The buffer conveyors 1106A and 1106B may be configured to move or shift FOUPs 106 in both forward and backward directions under control of a computing system (e.g., the computing system 126). The turntables 1108A and 1108B comprise transference nodes between the buffer conveyors 1106 and the stocker 1104. The turntable 1108A may be configured to transfer the FOUPs 106 from the active stocker buffer system 1102 to a stocker input port 1110. Likewise, the turntable 1108B may be configured to transfer the FOUPs 106 from a stocker output port 1112 to the active stocker buffer system 1102.

The active buffer system 1102 may be configured to buffer the delivery of FOUPs 106 to the stocker 1104 for storage. The buffer conveyor 1106B may be configured to receive the FOUPs 106 from an OHT system 1114. For example, an OHT vehicle 1116 may travel on an OHT track 1118 while carrying one of the FOUPs 106. When the OHT vehicle 1116 reaches a buffer input point 1120, the OHT vehicle 1116 may place the FOUP 106 onto the buffer conveyor 1106B. The buffer conveyor 1106B may be configured to move the FOUP 106 toward the turntable 1108B. If there is already another FOUP 106 on the buffer conveyor 1106B when the OHT vehicle 1116 reaches the buffer input point 1120, the buffer conveyor 1106B may move or shift the other FOUP(s) 106 already on the buffer conveyor 1106B such that an available position adjacent to the other FOUP(s) 106 is located at the buffer input point 1120 when the OHT vehicle 1116 places the FOUP 106 onto the buffer conveyor 1106B. The buffer conveyor 1106B may then move the FOUP 106 toward the turntable 1108B along with any of the other FOUP(s) 106 that may already be present on the buffer conveyor 1106B. When the turntable 1108B is empty, the turntable 1108B may rotate into position to receive the FOUP 106 which is closest to the turntable 1108B. After the FOUP 106 is moved onto the turntable 1108B, the turntable 1108B may rotate into position to transfer the FOUP 106 to the stocker input port 1110. The turntable 1108B may then transfer the FOUP 106 to the stocker input port 1110 when the stocker is ready to store the FOUP 106. After the turntable 1108B is empty again, the turntable 1108B may rotate into position to receive the next FOUP 106 which is closest to the turntable 1108B.

The active buffer system 1102 may also be configured to buffer the retrieval of the FOUPs 106 from the stocker 1104. When the stocker 1104 retrieves a stored FOUP 106 and delivers the stored FOUP 106 to the stocker output port 1112, the active buffer system 1102 may turn the turntable 1108A to receive the stored FOUP 106 from the stocker output port 1112. After the stored FOUP 106 is moved from the stocker output port 1112 to the turntable 1108A, the turntable 1108A may rotate to position the stored FOUP 106 to be transferred to the buffer conveyor 1106A. If there are one or more other FOUPs 106 already on the buffer conveyor 1106A, the buffer conveyor 1106A may shift or move the other FOUP(s) 106 such that the turntable 1108A may transfer the stored FOUP 106 to the buffer conveyor 1106A adjacent to the other FOUP(s) 106 already on the buffer conveyor 1106A. After the turntable 1108A transfers the stored FOUP 106 onto the buffer conveyor 1106A, the buffer conveyor 1106A may move the stored FOUP 106 along with any other FOUP(s) 106 already on the buffer conveyor 1106A near a buffer output point 1122. An OHT system 1124 may be configured to retrieve the FOUPs 106 from the active stocker buffer system 1102 at the buffer output point 1122. An OHT vehicle 1126 may travel on an OHT track 1128 to the buffer output point 1122 and pick up the stored FOUP 106 from the buffer output point 1122. The OHT vehicle 1126 may then move the stored FOUP 106 to another location, and the buffer conveyor 1106A may move another FOUP 106 into position at the buffer output point 1122 for pick up by another OHT vehicle 1126.

In transport systems of the prior art, a bottleneck may be created by deliveries between OHT systems (e.g., the OHT systems 1114 and 1124) and stockers (e.g., the stocker 1104). This is because the stocker input port 1110 and/or the stocker output port 1112 may be blocked while waiting for the arrival of an OHT vehicle and completion of the transfer of a FOUP 106 between the OHT vehicle and the stocker port. By buffering the FOUPs 106 for storage in the stocker 1104 and retrieval from the stocker 1104, the active stocker buffer system 1102 may minimize or reduce a time required for the OHT vehicle 1116 to be occupied delivering the FOUP 106 to the active stocker buffer system 1102 compared to a time that would be required for the OHT vehicle 1116 to be occupied delivering the FOUP 106 directly to the stocker 1104. Likewise, the active stocker buffer system 1102 may minimize or reduce delays of other OHT vehicles that may also be traveling on the OHT track 1118 and be blocked by the OHT vehicle 1116 that is delivering the FOUP 106 for storage in the stocker 1104. Similar benefits may be obtained for the OHT system 1124 in regards to retrieving the FOUPs 106 from the active stocker buffer system 1102.

The active buffer system 1102 may emulate a stocker (e.g., behave as a virtual stocker) in regards to operation of transportation control system software running on the computing system 126 (e.g., master control software (MCS), which may conform to a Semiconductor Equipment and Materials International (SEMI®) E88 Stocker Specific Equipment Model (STKSEM) interface for host communications). By emulating a stocker, the active stocker buffer system 1102 may cause the MCS to recognize the buffer input point 1120 as a stocker input port. Likewise, the buffer output point 1122 may be recognized as a stocker output port by the MCU. Regardless of a configuration of the active stocker buffer system 1102 (or any other buffer system as described herein, such as buffer systems 702, 802, 902, and 1002), the MCS may interface with the active stocker buffer system 1102 as if the active stocker buffer system 1102 were a standard stocker having a standard stocker interface (e.g., conforming to the E88 STKSEM interface). The MCU may control handoffs to and from the active stocker buffer system 1102 according to a SEMI E84 standard.

In various embodiments, a conveyor system and/or a buffer system, as described herein, may also be configured to emulate a transport vehicle in an interface with the MCS (e.g., for purposes of MCS logic and reporting). In these embodiments, the conveyor system may be configured to respond to commands and communications from the MCS as if the conveyor system were a transport vehicle according to a SEMI E82 standard.

By configuring a buffer system as a virtual stocker (e.g., emulating a stocker), the MCS may control the buffer system to transfer a selected FOUP 106 from one transport system (e.g., an OHT system) to another, although the MCS may not be programmed to perform these transfers directly. The MCS may cause the transfer of the selected FOUP 106 from a first OHT system to the virtual stocker according to a SEMI E88 standard. The MCS may then cause the transfer of the selected FOUP 106 from the stocker to a second OHT system using the SEMI E88 standard. The virtual stocker may transfer the FOUP 106 from the first OHT system to the second OHT system using the SEMI E82 standard without involving a physical stocker. In this way, functionality and flexibility of the MCS may be extended without modification and through adherence to existing standards.

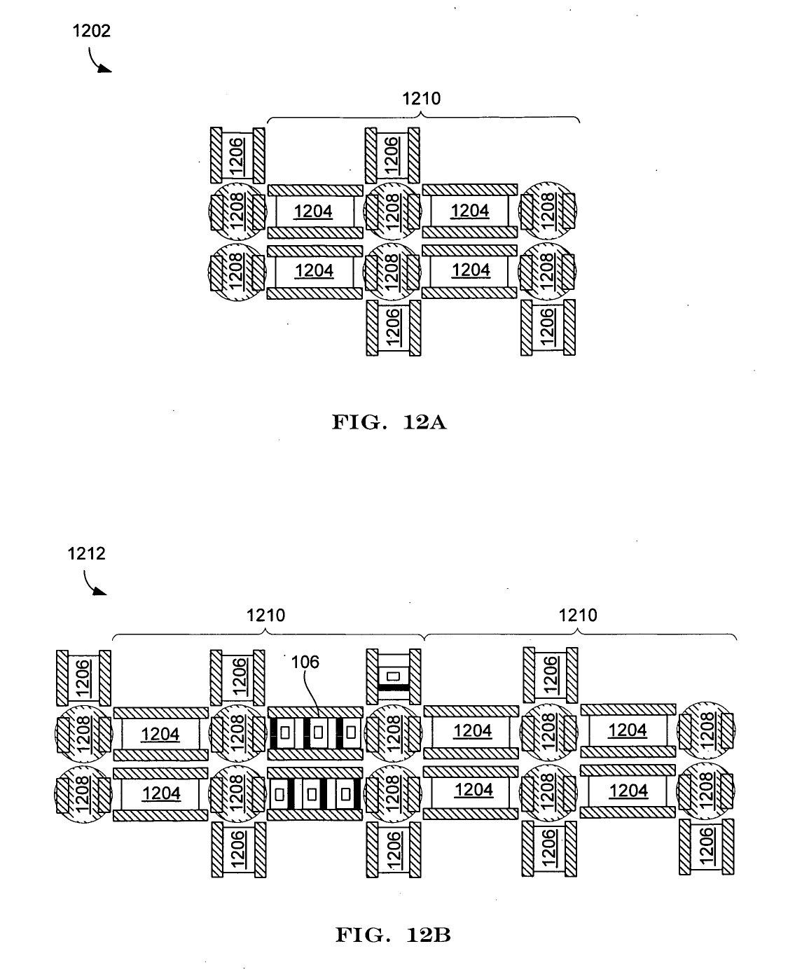

FIG. 12A is a top view of a buffer module 1202 including conveyance sections (e.g., buffer conveyors 1204), according to an embodiment of the present invention. The buffer module 1202 further includes turntables 1208 configured to transfer FOUPs 106 between buffer conveyors 1204 and buffer I/O conveyors 1206. The buffer module 1202 is similar to the buffer system 1002, except that turntables 1208 are used instead of curved buffer conveyors at the ends of the buffer system 1002. The buffer system 1202 includes a repeatable buffer module 1210. By adjoining multiple repeatable buffer modules 1210 with the buffer module 1202, larger buffer systems may be constructed in a straightforward manner. Capacity of existing buffer systems in a fabrication facility may be expanded by adding additional repeatable buffer modules 1210 to the existing buffer systems. A computing system (e.g., the computing system 126) may include logic configured to control the buffer module 1202.

FIG. 12B is a top view of a buffer system 1212 comprising multiple repeatable buffer modules 1210 integrated together, according to an embodiment of the present invention. As illustrated in FIG. 12B, a buffer system's storage capacity may be expanded by adjoining additional repeatable buffer modules 1210. In addition, the number of buffer I/O conveyors 1206 and transfer nodes associated with the buffer I/O conveyors 1206 may scale with the size of the buffer system 1212. By scaling I/O capacity with storage capacity, the buffer system 1212 can scale article throughput with storage capacity, as well.

For example, the buffer system 1202 comprising four buffer conveyors 1204 may have a storage capacity of 12 FOUPs 106. The buffer system 1212, which comprises eight buffer conveyors 1204, may have double the storage capacity of the buffer system 1202, or a storage capacity of 24 FOUPs 106. The number of FOUPs 106 which the buffer system 1212 can retrieve simultaneously may be directly proportional to the number of buffer I/O conveyors included in the buffer system 1212. Unlike a stocker, which may only output a single FOUP 106 at a time in response to a series of retrieval requests, the buffer system 1212 may output as many requested FOUPs 106 simultaneously as a quantity of buffer I/O conveyors 1206 configured as buffer output points. A stocker's article throughput may be constant regardless of stocker storage capacity, or may decrease with stocker storage capacity. The buffer system 1212's article throughput, on the other hand, may increase with the buffer system 1212's storage capacity.

The logic configured to control the buffer module 1202 may be configured to control storage, movement, and retrieval of the FOUPs 106 in the repeatable buffer module 1210 as a unit in an object oriented fashion. The computing system may therefore use the same logic for each additional repeatable buffer module 1210 which may be added to the buffer system 1212. In some embodiments, each repeatable buffer module 1210 may be controlled as an individual buffer system. The computing system may control any size buffer system comprising the repeatable buffer modules 1210 by using the object oriented logic for each individual repeatable buffer module 1210 in an integrated fashion. In this way, the repeatable buffer modules 1210 in the buffer system 1212 may seamlessly interoperate under control of the computing system to buffer the FOUPs 106.

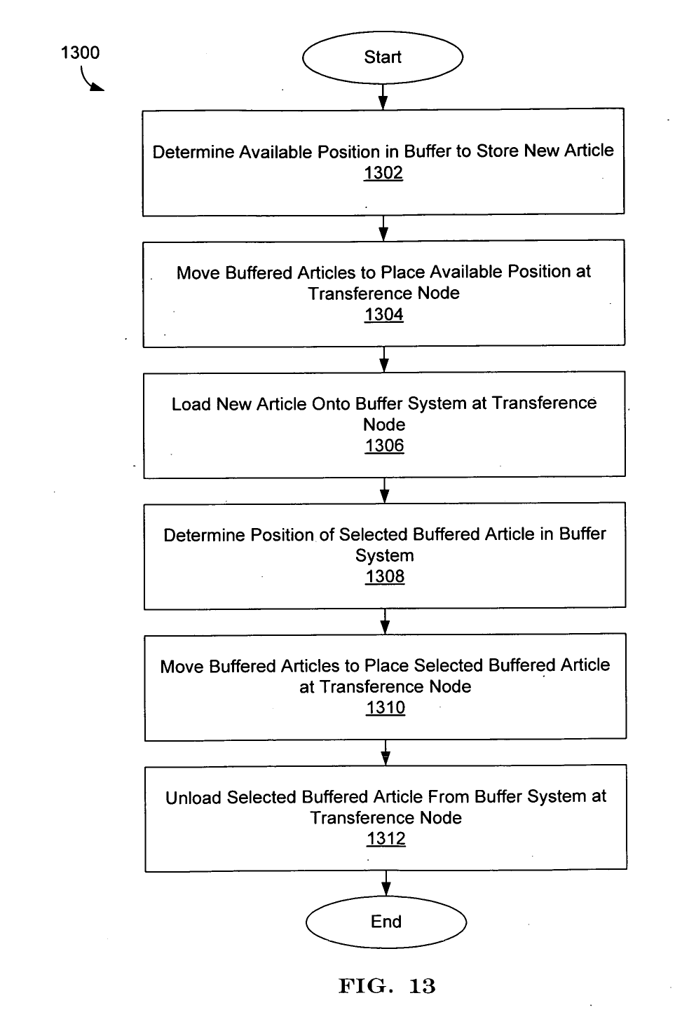

FIG. 13 is a flowchart representation of a method 1300 of buffering articles (e.g., the FOUPs 106) in transport in a conveyor system (e.g., the conveyor system 1000), according to an embodiment of the present invention. The method 1300 may start with “start” and end with “end.” In various embodiments, steps of method 1300 may be performed in a different order than illustrated, and some steps may be performed while other steps are not performed.

In a step 1302, an available position to store an input FOUP 106 in a buffer system (e.g., the buffer system 1002) is determined. The buffer system 1002 may already have one or more FOUPs 106 stored, or buffered. The available position may be determined by accessing an inventory list itemizing and containing information regarding the position and/or contents of the FOUPs 106 stored in the buffer system 1002. The inventory list may be maintained by a computing system (e.g., the computing system 126). The available position may be determined according to rules related to the size of the trains of buffered FOUPs 106 already stored in the buffer system 1002. The available position may be selected by first selecting a train of buffered FOUPs 106 having available capacity to accept the input FOUP 106, and then determining an input position within the train at which to add the input FOUP 106 (e.g., the head position 1012 or the tail position 1014).

For example, an available position may be chosen based on a number of free storage positions on a given buffer conveyor 1004 which is storing the train having the chosen available position. A train having the most free storage positions may be chosen. Alternatively, if multiple FOUPs 106 to be stored are to be stored in the buffer system 1002 via multiple buffer I/O conveyors 1008 simultaneously (e.g., via buffer I/O conveyors 1008A and 1008C), the available positions may be chosen based on which trains can be simultaneously moved into position to receive the multiple FOUPs 106 at the turntables 1010A and 1010C to be stored in the least amount of time.

In a step 1304, the buffered FOUPs 106 that are stored in the buffer system 1002 are moved and/or shifted such that the available position determined in step 1302 is at a chosen input node (e.g., a transference node at the turntable 1010A or the turntable 1010C). The buffered FOUPs 106 may be moved or shifted in one or more directions by the buffer conveyors 1004, curved buffer conveyors 1006, and/or turntables 1010. Different buffered FOUPs 106 may be moved or shifted in different directions from each other. The computing system 126 may include move logic configured to control each of the buffer conveyors 1004, curved buffer conveyors 1006, and turntables 1010 independently such that their movements are coordinated with one another as a unit to perform the functionality of the buffer system 1002.

For example, if the input FOUP 106 is to be stored in the buffer system 1002 via the buffer I/O conveyor 1008A, the computing system 126 may determine in step 1302 that an available position is after the tail position 1014B. The computing system 126 may then control the buffer system 1002 to shift the buffered FOUPs 106 in the train between the head position 1012B and the tail position 1014B backward such that the tail position 1014B is located at the buffer conveyor 1004H near the turntable 1010A. If there are other buffered FOUPs 106 between the tail position 1014B and the turntable 1010A prior to this shift operation, the buffer system 1002 may move these other buffered FOUPs 106 out of the way at the same time. In case there are free positions between these other buffered FOUPs 106 and the tail position 1014B, the free positions may be eliminated and the train having the tail position 1014B may be merged with a train including the other buffered FOUPs 106. These merge, move, and shift operations may be orchestrated and controlled by the computing system 126 to minimize or reduce the time required to complete the storage of the input FOUP 106, to minimize or reduce the expected time to complete a retrieval operation in the future, and/or to balance the number of buffered FOUPs 106 stored on each buffer conveyor 1004 in the buffer system 1002.

In a step 1306, the input FOUP 106 to be stored in the buffer system 1002 is loaded onto the buffer system 1002 at the chosen input node (e.g., the transference node at the turntable 1010A). Continuing the previous example, the turntable 1010A may be positioned to receive the input FOUP 106 to be stored in the buffer system 1002, and the buffer I/O conveyor 1008A may then move the input FOUP 106 onto the turntable 1010A. The turntable 1010A may then turn the input FOUP 106 to align the input FOUP 106 with the train between the head position 1012B and the tail position 1014B. The buffer system 1002 may then move the train and the input FOUP 106 forward simultaneously such that the FOUP 106 takes its place to establish a new tail position 1014B of the train, and the train may be moved forward to a storage position such that the head position 1012B is placed near the turntable 1010B as before. In other embodiments, the input FOUP 106 may be added to a head position 1012 of a train instead of a tail position 1014. In additional embodiments, the input FOUP 106 may be added to a position between the head position 1012 and the tail position 1014 of a train.

If adding the input FOUP 106 to the train causes the train to become longer than can be stored within a single buffer conveyor 1004, the computing system 126 may break the train into two or more trains, each of which may be stored on a separate buffer conveyor 1004. While moving the buffered FOUPs 106 to position the available position at the chosen input node to receive the input FOUP 106 for storage in the buffer system 1002, the computing system 126 may transfer one or more of the buffered FOUPs 106 from one train to another in order to minimize or reduce a number of turns by the turntables 1010, to minimize or reduce a time required to complete the storage of the input FOUP 106, and/or to minimize or reduce an expected time required to retrieve a random buffered FOUP 106 in the future.

In some embodiments, the computing system 126 may control the buffer system 1002 to move a particular buffered FOUP 106 from one train to another train via the buffer conveyor 1004I between the turntables 1010B and 1010D. However, the computing system 126 may first check to see whether the turntables 1010B and/or 1010D are in a path of another train's move operation. If either of the turntables 1010B or 1010D is not in the path of a third train's move operation, the buffer system 1002 may move the particular buffered FOUP 106 from the one train to the other train via the buffer conveyor 1004I. Otherwise, the buffer system 1002 may need to complete the third train's move operation first, or determine a different plan for reorganizing the trains of buffered FOUPs 106.

In a step 1308, a position of a selected buffered FOUP 106 in the buffer system 1002 is determined. The computing system 126 may locate the position of the selected buffered FOUP 106 by accessing the inventory list itemizing and containing information regarding the position and/or contents of the FOUPs 106 stored in the buffer system 1002. The selected buffered FOUP 106 may be selected to be retrieved from the buffer system 1002 for transport to an external location, such as a process equipment bay, a stocker, another buffer system, etc.

In a step 1310, the buffered FOUPs 106 in the buffer system 1002 are moved and/or shifted such that the selected buffered FOUP 106 is positioned at a chosen output node (e.g., a transference node at the turntable 1010B or 1010D). The move and shift operations performed in step 1310 may be similar to the move and shift operations described with reference to step 1304 above. For example, the computing system 126 may control the buffer system 1002 to move and/or shift the buffered FOUPs 106 such that the selected buffered FOUP 106 is positioned at the chosen output node (e.g., the transference node at the turntable 1010B).

In a step 1312, the selected buffered FOUP 106 may be unloaded from the buffer system 1002 at the chosen output node. Continuing the previous example described with reference to step 1310, the turntable 1010B may be turned to direct the selected buffered FOUP 106 toward the buffer I/O conveyor 1008B. The turntable 1010B and the buffer I/O conveyor 1008B may then cause the selected buffered FOUP 106 to move out of the buffer system 1002 onto the adjoining turntable 712 which is part of the conveyor 1018. After the turntable 1010B is no longer holding the selected buffered FOUP 106, the turntable 1010B may rotate into position to transfer the buffered FOUPs 106 remaining in the buffer system 1002 from one buffer conveyor 1004 adjoining the turntable 1010B to another. The buffer system 1002 may then move the buffered FOUPs 106 to close a gap in the middle of a train where the selected buffered FOUP 106 had been stored. The buffer system 1002 may also transfer one or more buffered FOUPs 106 from one train to another and/or move the trains to minimize or reduce an expected time required to store or retrieve a new FOUP 106 in the future, or optimize the distribution of the buffered FOUPs 106 among trains and/or buffer conveyors 1004 in the buffer system 1002.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A system for buffering articles in transport comprising:
a buffer module configured to buffer articles, the buffer module including
a first conveyor configured to transport the articles,
a transference node configured to transfer the articles between the first conveyor and an external location; and
a computing system configured to
maintain an inventory list including a present location of each of the articles buffered by the buffer module, and
control operation of the buffer module to transfer a selected article among the buffered articles to the external location.

2. The system of claim 1, wherein the first conveyor includes a curved conveyance section.

3. The system of claim 1, wherein the first conveyor includes a first end and a second end, both of which are disposed proximate to the transference node, and the transference node is further configured to transfer the articles between the first end and the second end.

4. The system of claim 1, wherein the buffer module further includes a second conveyor configured to transport the articles, and the transference node is further configured to transfer the articles between the first conveyor, the second conveyor, and the external location.

5. The system of claim 4, wherein the first conveyor and the second conveyor are arranged in different vertical layers.

6. The system of claim 1, wherein the computing system is further configured to control operation of the buffer module such that the selected article is transferred to the external location without first transferring an other article to the external location.

7. The system of claim 1, wherein the first conveyor comprises two vertical belts.

8. The system of claim 1, wherein the transference node includes a turntable.

9. The system of claim 1, wherein the transference node includes an elevator.

10. The system of claim 1, wherein the external location is at a different layer than the first conveyor.

11. The system of claim 1, wherein the buffer module comprises a plurality of buffer modules configured to seamlessly interoperate under control of the computing system to buffer the articles.

12. The system of claim 11, wherein the computing system includes logic configured to control each of the plurality of buffer modules independently as independent units.

13. A method for buffering an article in transport, the method comprising:
determining an available position among a plurality of buffered articles in a buffer system, the buffer system comprising a conveyor, a first transference node, and a second transference node;
moving the plurality of buffered articles in the buffer system using the conveyor and the transference nodes such that the available position is at the first transference node;
loading the article onto the buffer system at the first transference node;
determining a position of a selected buffered article in the buffer system;
moving the plurality of buffered articles in the buffer system using the conveyor and the transference nodes such that the selected buffered article is at the second transference node; and
unloading the selected buffered article from the buffer system at the second transference node.

14. The method of claim 13, wherein the buffer system comprises logic configured to cause the buffer system to appear as an automated storage and retrieval system (ASRS) to a transportation control system.

15. The method of claim 13, wherein moving the plurality of buffered articles in the buffer system comprises moving a buffered article from a first layer to a second layer at another elevation.

16. The method of claim 13, wherein the first transference node and the second transference node are the same transference node.

17. A method for buffering an article in transport, the method comprising:
selecting a train of buffered articles having available capacity to accept an input article, the train of buffered articles being stored by a buffer system comprising a conveyor and a transference node;
moving the train of buffered articles using the conveyor such that an input position is at the transference node;
loading the input article onto the buffer system at the transference node;
moving the train of buffered articles including the loaded input article to a storage position using the conveyor.

18. The method of claim 17, wherein the input position is at a tail position of the train of buffered articles.

19. The method of claim 17, wherein the input position is at a head position of the train of buffered articles.

20. The method of claim 17, wherein the storage position is near an output node of the buffer system.

21. The method of claim 17, wherein a spacing between the buffered articles of the train is less than a dimension of the buffered articles.

22. A computer readable storage medium having stored thereon computing instructions comprising:
a code segment to determine an available position among a plurality of buffered articles in a buffer system, the buffer system comprising a conveyor, a first transference node, and a second transference node;
a code segment to control the buffer system to move the plurality of buffered articles using the conveyor and the transference nodes such that the available position is at the first transference node;
a code segment to control the buffer system to load the article onto the buffer system at the first transference node;
a code segment to determine a position of a selected buffered article in the buffer system;
a code segment to control the buffer system to move the plurality of buffered articles using the conveyor and the transference nodes such that the selected buffered article is at the second transference node; and
a code segment to control the buffer system to unload the selected buffered article from the buffer system at the second transference node.

23. The computer readable storage medium of claim 22, wherein the computing instructions further comprise a code segment configured to cause the buffer system to appear as an automated storage and retrieval system (ASRS) to a transportation control system.

24. The computer readable storage medium of claim 22, wherein the computing instructions further comprise a code segment configured to move a buffered article from a first layer to a second layer at another elevation.

25. The computer readable storage medium of claim 22, wherein the first transference node and the second transference node are the same transference node.
